(19) United States
(12) Patent Application Publication
(10) Pub. No.: US 2008/0094460 A1
(43) Pub. Date: Apr. 24, 2008

(54) LIGHT IRRADIATION DEVICE AND INKJET PRINTER UTILIZING SAME

(75) Inventors: Shigenori NAKATA, Yokohama-shi (JP); Katsuya WATANABE, Yokohama-shi (JP)

Correspondence Address: ROBERTS, MLOTKOWSKI & HOBBES, P. O. BOX 10064, MCLEAN, VA, 22102-8064, US

(73) Assignee: Ushiodenki Kabushiki Kaisha, Tokyo (JP)

(21) Appl. No.: 11/874,335

(22) Filed: Oct. 18, 2007

(30) Foreign Application Priority Data
Oct. 18, 2006 (JP) 2006-283551

(51) Int. Cl. B41J 2/01; H01K 1/30

(52) U.S. Cl. 347/102; 313/113

(57) ABSTRACT

A light irradiation device and an inkjet printer equipped with the light irradiation device, the light irradiation device having a short-arc type discharge lamp with a pair of electrodes which face each other within a discharge vessel, a reflector surrounding the discharge lamp so as to reflect light from the discharge lamp, and a cylindrical lens that focuses light reflected by the reflector in a uniaxial direction in a manner forming a light irradiation zone having an elongated linear shape. Plural lamps with respective reflectors and lenses can be arranged in a row to increase the size of the linear irradiation zone formed.

### BACKGROUND OF THE INVENTION

1. Field of the Invention

This invention relates to a light irradiation device and an inkjet printer. In particular, it concerns a light irradiation device that forms a long, narrow, linear light irradiation zone on the article to be irradiated and an inkjet printer in which the light irradiation device is mounted that prints images, circuits or other patterns on a substrate by ejecting a light-curable liquid material onto the substrate.

2. Description of the Related Art

Because it is able to produce images more conveniently and cheaply than the gravure method, in recent years the inkjet recording method has been adopted in a variety of printing fields including specialty printing, such as photographs, printing of various kinds, marking, and color filters.

With inkjet printers using the inkjet printing method, it is possible to obtain high graphic quality by combining inkjet printers of the inkjet recording method that eject and control fine dots, inks with improved color reproduction, durability, and ejection properties, and specialty papers with greatly improved ink absorption, color development properties, and surface gloss.

Generally, these inkjet printers can be classified by the type of ink, but among them there is a light-cure inkjet method that uses light-curable inks that are cured by irradiation with ultraviolet or other radiation.

The light-cure inkjet method is a relatively low-odor process and has the advantages of quick drying even with non-specialty papers and the ability to print even on recording media that do not absorb ink.

With inkjet printers of this light-cure inkjet type (called “inkjet printers” hereafter), a light source that irradiates the ink with light is mounted on a carriage along with the inkjet head that ejects ink in the form of small droplets onto the substrate; the carriage is moved with the light source lighting the substrate, and the ink is cured by irradiation with the light immediately after it impacts the substrate (see, for example, Japanese Pre-grant Patent Report 2005-246955 and corresponding U.S. Patent Application Publication 2005/168509, Japanese Pre-grant Patent Report 2005-103852, Japanese Pre-grant Patent Report 2005-305742, and Noguchi Hiromichi, Orikasa Teruo, “Trends of UV Inkjet Printing,” Bulletin of the Japanese Society of Printing Science and Technology, Vol. 40, No. 3, p. 32 (2003)).

Now, there have been attempts in recent years to use inkjet printers not only for record printing of images as mentioned above, but also for forming electronic circuit patterns. In this case, the liquid material that is from the inkjet head is a material for making circuit boards, such as a light-curable resist ink; the substrate on which printing (that is, pattern formation) is done is, for example, a printed-circuit board.

Formation of circuit patterns by means of resist ink, like printing of images, has used a dry and cure reaction by means of UV or other radiation and the material ejected from the inkjet head is different from resist or ink, but the constitution of the inkjet printer equipment is the same.

Equipment that records images on a substrate using light-curable ink is explained below as an example of an inkjet printer.

As shown in FIG. 11, the inkjet printer has an inkjet head 71 fitted with nozzles (not illustrated) that eject fine droplets of, for example, a liquid ink that is cured by ultraviolet radiation, and two light irradiation devices 80A, 80B that are located on both sides, for example, of the inkjet head 71 and that cure the ink, which is the liquid material that has impacted on a substrate R, by irradiating it with ultraviolet light; these are part of the head portion 70 that is mounted on a carriage 72.

The head portion 70 is supported by a bar-shaped guide rail 75 that is placed to extend along the substrate R, and can be moved by a unillustrated drive mechanism (not illustrated) back and forth along the guide rail 75 above the substrate R.

The light irradiation devices 80A, 80B have box-shaped covers 81 with light output openings 81A that open in the direction of the position of the substrate R (downward in FIG. 11). Long-arc type discharge lamps 82 that form light sources are placed inside the covers 81 so as to extend parallel to the substrate R in a direction perpendicular to the direction of movement of the head portion 70. In positions behind the discharge lamps 82 relative to the light output openings 81A are barrel-shaped reflectors 83 that have elliptical reflecting surfaces 83A that reflect the light emitted by the discharge lamps 82; these reflectors 83 are placed to extend along the length of the discharge lamps 82 with the discharge lamps 82 positioned at their first focal points Fr1.

High-pressure mercury lamps or metal halide lamps, for example, are used as the discharge lamps 82; the length of the light-emitting portion is of a size to form a light irradiation zone IA that is, for example, larger that the dimension of the substrate R perpendicular to the direction of movement of the head portion 70 (width dimension).

In this inkjet printer, the head portion 70 is located so that the substrate R is positioned at or in the vicinity of the second focal points Fr2 of the reflectors 83 of the light irradiation devices 80A, 80B. By moving the position of the head portion 70 above the substrate R while the discharge lamps 82 are lit, it is possible for the light from the discharge lamps 82 to be focused in a line on the substrate R that is positioned at the second focal points Fr2 of the reflectors 83, irradiating the substrate R in addition to the direct light from the lamps 82, by which means the ultraviolet light-curable ink is cured immediately after impacting the substrate R.

To give a basic explanation of the process of curing ultraviolet light-curable ink (the process of ultraviolet irradiation of ultraviolet light-curable ink), when printing of substrate R is being done while the print head portion moves to the right in FIG. 11, for example, the ultraviolet light-curable ink that has impacted the substrate R is cured by light irradiated from the light irradiation device 80A that is positioned to the rear in the direction of movement of the head portion 70, but when printing of substrate R is being done while the print head portion moves to the left in FIG. 11, the ultraviolet light-curable ink that has impacted the substrate R is cured by light irradiated from the other light irradiation device 80B that is then positioned to the rear in the direction of movement of the head portion 70.

Recently there has come to be a desire for higher graphic quality in inkjet printers using the light-cure inkjet recording method described above, accompanied by a desire for even faster curing of the ink. The reason for this is as follows.

That is, as described in Noguchi Hiromichi, Orikasa Teruo, “Trends of UV Inkjet Printing,” Bulletin of the Japanese Society of Printing Science and Technology, Vol. 40, No. 3, p. 32 (2003), radical polymer inks have the property that the concentration of radicals drops in the presence of oxygen, and so, if the polymerization reaction takes time, the period of exposure to the open air is prolonged, the curing speed is slowed, and a longer period is required to cure the ink.

The ink used in the inkjet printer must have low viscosity, to some extent, to be ejected smoothly from the nozzles of the inkjet head, and so curing takes time. In other words, if the ink is not cured (photopolymerized) immediately after impacting the substrate, the shape of the dot of ink will change after impact and image quality is reduced.

To meet such demands, it is thought that photopolymerization can be made to progress more quickly by increasing the peak irradiance of the light irradiated by the light irradiation device.

For example, the Noguchi Hiromichi, Orikasa Teruo, “Trends of UV Inkjet Printing,” Bulletin of the Japanese Society of Printing Science and Technology, Vol. 40, No. 3, p. 32 (2003) cited above states that it is possible to lessen the degree that the speed of ink curing drops because of oxygen, or in other words, it is possible to prevent a decrease in image quality, by speeding up the ink curing process; it also states that it is possible to form a light irradiation region of equal size to that produced by a long-arc type discharge lamp and that a microwave UV lamp is effective in yielding higher irradiance than a long-arc type discharge lamp. The peak irradiance of the microwave UV lamp mentioned in this publication is in the range of 1000 to 1200 W/cm².

Further, Japanese Pre-grant Patent Report 2005-103852, cited above, describes technology to locate lenses between multiple light source lamps, located on a plane, and the substrate, and to increase the peak irradiance irradiating the substrate by means of focusing light from the light source lamps to irradiate the substrate.

However, even when irradiating with light focused from light source lamps using optical elements such as lenses and mirrors, the peak irradiance yielded will be limited unless the radiance of the light source lamps themselves is increased; this is the case even when using the microwave UV lamps indicated in the Noguchi Hiromichi, Orikasa Teruo publication mentioned above.

It is thought that there will be further demands to increase the peak irradiance of the light irradiating the substrate in the future; to satisfy these demands it will be necessary to further increase lamp radiance.

However, the reality is that it is technically difficult to further increase the radiance of long-arc lamps, which have large light-emitting portions, or microwave UV lamps.

Further, there are also the following problems in the inkjet printers described above. That is, in a conventional inkjet printer having the constitution shown in FIGS. 11(a) & 11(b), for example, the light-output openings 81A of the light irradiation devices 80A, 80B and the light irradiation openings 83B of the reflector 83 open in the same direction facing each other. Accordingly, as shown in FIG. 11(b), the light from the discharge lamp 82 directly irradiates the substrate R, but of the light that is output by the discharge lamp 82, there is light in the visible through infrared region that is not needed for curing ultraviolet light-curable ink, and thermal radiation from the arc tube of the discharge lamp 82, which reach high temperatures when the lamp is lit, that is also incident on the substrate R, and so the substrate R is heated by the light in the visible through infrared region and the thermal radiation.

A material that is easily deformed by heat, such as paper, resin, or film, is often used as the substrate R, and so simply using a lamp with high power to increase the irradiance will increase the effect of heat on the substrate R due to light in the visible through infrared region and the thermal radiation, which will raise the temperature of the substrate R even higher and cause deterioration of print quality because of such things as deformation.

One possible means to deal with such problems is to reduce the effect of heat on the substrate by placing a reflecting mirror having a vapor-deposited film that reflects only light of the wavelengths needed to cure the ink and allows light of other wavelengths to pass through (also called a cold mirror) between the discharge lamp and the substrate.

However, if a reflecting mirror of this type is put in place, the optical path from the discharge lamp to the substrate is lengthened by that much, so that it is not possible, in the case of a long-arc type discharge lamp, for example, to focus the light with respect to the lengthwise direction of the discharge lamp, and so the area irradiated by the light (the light irradiation zone) expands, efficiency of light use drops, and the light irradiation surface (the surface of the substrate) cannot receive high enough irradiance.

As stated above, the situation is that it is difficult, in an inkjet printer using the light-curable inkjet method, to increase the peak irradiance in the light irradiation surface above the conventional level, thus improving the ink-curing process.

In inkjet printers using the light-cure inkjet method, in addition to improving the ink-curing process, there is a desire to make the equipment smaller and lighter and to increase the printing speed. Therefore, it is desirable to make the head portion as small as possible and as light as possible, and thus, shorten the start-stop time and enable faster movement of the head portion. If the weight of the head portion is great, more time is required to start and stop movement of the head portion, and so it is not possible to improve the printing speed even if the ink-curing time is shortened.

To increase the printing speed requires increasing the torque of the drive motor, and so a large motor is necessary. With that comes the necessity of a sturdy frame for support, and the overall weight, size, and cost of the inkjet printer increases greatly.

### SUMMARY OF THE INVENTION

The present invention was made on the basis of the situation described above so that a first object is to provide a light irradiation device that irradiates linearly focused light, in which high peak irradiance can be obtained.

A second object of the invention is to provide a light irradiation device that irradiates linearly focused light, in which rapid movement of the head portion is possible in the event that it is used as a light irradiation device in the head portion of an inkjet printer.

A third object of the invention is to provide an inkjet printer fitted with that light irradiation device that is capable of curing light-curable inks or other liquid materials with high efficiency, thus capable of reliably forming high-quality images and patterns, and also capable of increasing the speed of printing or pattern formation.

The present inventors discovered, as a result of diligent research, that the problem described above could be resolved by using a short-arc type discharge lamp having high radiance instead of a long-arc type discharge lamp and structuring it with an optical system that irradiates by focusing the light from the discharge lamp to extend in a line, and so completed the invention

That is, the light irradiation device of this invention is characterized by the following constitution.

(1) It has a short-arc type discharge lamp that comprises a pair of electrodes placed facing each other within a discharge vessel, a reflector, placed to surround the discharge lamp, that reflects the light from the discharge lamp, and a cylindrical lens that focuses the incident light reflected by that reflector in a uniaxial direction, and so forms a light irradiation zone by focusing the light from the discharge lamp to extend in a linear shape.

The cylindrical lens is a lens that focuses incident light in a uniaxial direction (the direction of one axis of two perpendicular axes of the plane perpendicular to the optical axis of the incident light); those that are commercially available have a columnar shape divided in two lengthwise with the lower surface forming a semicircle. Now, of the two axes of the cylindrical lens mentioned above, the direction in which the light is focused is called the focusing direction hereafter, and the direction that is not focused is called the axial direction.

(2) In (1) above, the reflector used is one with a reflecting surface that is a paraboloid of revolution centered on the beam axis.

When a reflector that has a reflecting surface that is a paraboloid of revolution is used and the emission point of the discharge lamp (the arc spot, for example) is placed at the focal point position of the reflector, the light will emerge from the reflector as collimated light. This collimated light is made incident on the cylindrical lens and focused into a line.

3) In a light irradiation device having a short-arc type discharge lamp that comprises a pair of electrodes placed facing each other within a discharge vessel, a reflector, placed to surround the discharge lamp, that reflects the light from the discharge lamp, and a cylindrical lens that focuses in only a uniaxial direction the incident light reflected by that reflector, and so forms a light irradiation zone by focusing the light from the discharge lamp to extend in a linear shape, there are, on the light output side of the reflector, reflecting mirrors having cylindrical reflecting surfaces that are parabolic in cross section (the cross section in the primary direction has a parabolic reflecting surface, and the cross section in the secondary direction, which is perpendicular to the primary direction, has a straight-line reflecting surface).

Like the cylindrical lens, these reflecting mirrors act to focus incident light in a uniaxial direction. Now, in the following, the direction in which the reflecting mirror does not focus light (the direction in which the barrel shape extends, or in other words, the direction in which the cross section is a straight line) is called the axial direction.

The reflecting mirrors are placed on both sides of the cylindrical lens so that the reflected light from the reflector is focused in linear shape on the focusing position of the cylindrical lens. That is, they are placed on both sides of the cylindrical lens so that the axial direction of the cylindrical lens and the axial directions of the reflecting mirrors are parallel, and the cylindrical lens is placed so that it focuses that part of the light reflected by the reflector that is not incident on the reflecting mirrors. By means of this constitution, the length of the cylindrical lens in the focusing direction can be smaller than the opening of the reflector, and the weight of the light irradiation device can be reduced.

(4) In a light irradiation device having a short-arc type discharge lamp that comprises a pair of electrodes placed facing each other within a discharge vessel, a reflector, placed to surround the discharge lamp, that has a reflecting surface that is an ellipsoid of revolution centered on the optical axis and that reflects the light from the discharge lamp, and a cylindrical lens that focuses in only a uniaxial direction the incident light reflected by that reflector, and so forms a light irradiation zone by focusing the light from the discharge lamp to extend in a linear shape, the cylindrical lens is located in a position where the size of the shaft of light focused by the reflector is smaller than the size of the opening of the reflector.

When a reflector that has a reflecting surface that is an ellipsoid of revolution is used and the emission point of the discharge lamp (the arc spot, for example) is placed at the first focal point position of the reflector, the light that emerges from the reflector will be focused at the second focal point position of the ellipsoidal reflector and then spread.

The cylindrical lens is located in a position where the light that is spread after being focused at the second focal point of that reflector is incident on it.

By means of this constitution, the length of the cylindrical lens in the focusing direction and the axial direction can be smaller than the opening of the reflector, and the weight of the light irradiation device can be reduced.

(5) It is possible to line up multiple light irradiation devices as described in any of points (1) through (4) above with at least a part (the ends) of the regions irradiated by adjoining irradiation devices overlapping in a direction perpendicular to the direction in which the light irradiation devices are lined up.

(6) In an inkjet printer having a head portion in which there is an inkjet head that ejects a light-curable liquid material onto a substrate and a light irradiation device that radiates light to cure the liquid material that is ejected onto and impacts the substrate, the inkjet printer forming a pattern by curing the liquid material by means of ejecting the liquid material from the inkjet head while there is relative movement between the head portion and the substrate and irradiating the liquid material that has impacted the substrate with light from the light irradiation device, the light irradiation device is a light irradiation device as described in any of points (1) through (5) above.

The following effects can be obtained with this invention.

(1) With the light irradiation device of this invention, a short-arc type discharge lamp is used as the light source lamp and the optical system is made up of a reflector and a cylindrical lens, by which means it is possible to focus the light from the short-arc type discharge lamp, which makes up a point light source, to extend linearly while suppressing spreading of the light irradiation zone on the light irradiation surface. It is therefore possible to use the light from the discharge lamp more efficiently and, since the discharge lamp itself is one of high radiance, it is possible to obtain high peak irradiance on the light irradiation surface.

Further, because of a constitution in which light from the light source lamp is reflected by a reflector and only the light reflected by the reflector emerges, it is possible in the case of emission of light in the ultraviolet region, for example, to use a multilayer vapor deposition mirror that reflects only ultraviolet rays as the reflector so that light in the visible through infrared regions included in the light radiated from the discharge lamp and thermal radiation that accompanies the lighting of the discharge lamp are not directly incident on the article to be irradiated, and so it is possible to minimize the effect of heat on the article to be irradiated.

(2) In the event that the reflector has a reflecting surface that is a paraboloid of revolution centered on the beam axis, placing reflecting mirrors that have cylindrical reflecting surfaces that are parabolic in cross section on two sides of the cylindrical lens along its axial direction, it is possible to reduce the size of the cylindrical lens.

Further, by giving the reflector a reflecting surface that is an ellipsoid of revolution centered on the beam axis, it is possible to reduce the size of the cylindrical lens and to reduce the weight of the light irradiation device as a whole.

(3) In an inkjet printer equipped with the light irradiation devices described above, light from the discharge lamps irradiates, with high peak irradiance, light-curable inks or other liquid materials that have impacted the substrate, and so it is possible to rapidly cure (light-polymerize) the liquid material immediately after it impacts the substrate, and to shorten the time needed for curing. It is possible, accordingly, to prevent changes to the shape of dots, and to form high-quality images and patterns.

With regard to the light that irradiates the substrate, however, especially when liquid materials such as ultraviolet light-curable inks are used, because the light from the light source lamp is reflected by a reflector and only the light reflected by the reflector emerges and because the reflector is a multilayer vapor-deposition mirror that reflects only ultraviolet rays, light in the visible through infrared regions included in the light radiated from the discharge lamp and thermal radiation that accompanies the lighting of the discharge lamp are not directly incident on the article to be irradiated. Accordingly, it is possible to minimize the effect of heat on the article to be irradiated, and to prevent deformation of the substrate.

With this invention, moreover, the light irradiation device (lighting fixture) can be made smaller and lighter than those equipped with long-arc type discharge lamps, and so it is possible to reduce the overall weight of the inkjet printer, and also to increase the print speed or pattern formation speed by improving curing efficiency of light-curable liquid materials.

### BRIEF DESCRIPTION OF THE DRAWINGS

FIGS. 1(a) & 1(b) are cross-sectional views showing the basic constitution of the light irradiation device of this invention.

FIGS. 2(a) & 2(b) show an example of constitution of the light irradiation device of the first embodiment of this invention.

FIGS. 3(a) & 3(b) show an example of constitution of the light irradiation device of a second embodiment of this invention.

FIG. 4 shows a first example of an embodiment of a light irradiation device having two light sources.

FIG. 5 shows a second example of an embodiment of a light irradiation device having two light sources.

FIG. 6 shows a modification of the third embodiment of a light irradiation device having two light sources.

FIG. 7 shows examples of configurations of the light irradiation zones.

FIG. 8 is a sectional view of the light irradiation device shown in FIGS. 1(a) & 1(b) applied in an inkjet printer head portion.

FIG. 9 is a sectional view of the light irradiation device shown in FIG. 2 applied in an inkjet printer head portion.

FIG. 10 is a sectional view of a variation of the light irradiation device shown in FIG. 3 applied in an inkjet printer head portion.

FIG. 11(a) is a perspective view showing the schematic structure of the head portion of a conventional inkjet printer; and FIG. 11(b) is a cross section, cut along the vertical plane of the light beam of the lamp of the light irradiation device shown in FIG. 11(a) and with FIG. 11(a) being drawn partially in outline form so that the interior of the light irradiation device is visible to facilitate the explanation that follows.

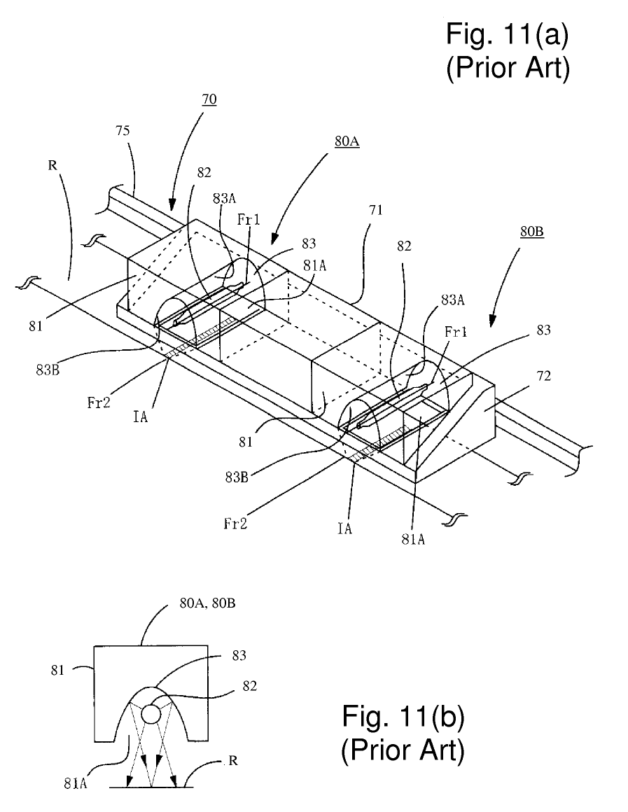

### DETAILED DESCRIPTION OF THE INVENTION

The light irradiation device and head portion of an inkjet printer that are the optimum embodiments of this invention are explained below.

(1) The basic constitution of the light irradiation device of this invention has at least one light source with a short-arc type discharge lamp and a reflector that reflects light from the discharge lamp, and a cylindrical lens that focuses and emits the incident light irradiated by the light source in only a uniaxial direction; the light from the discharge lamp is focused and irradiated so as to form a light irradiation zone that extends linearly on the light irradiation surface.

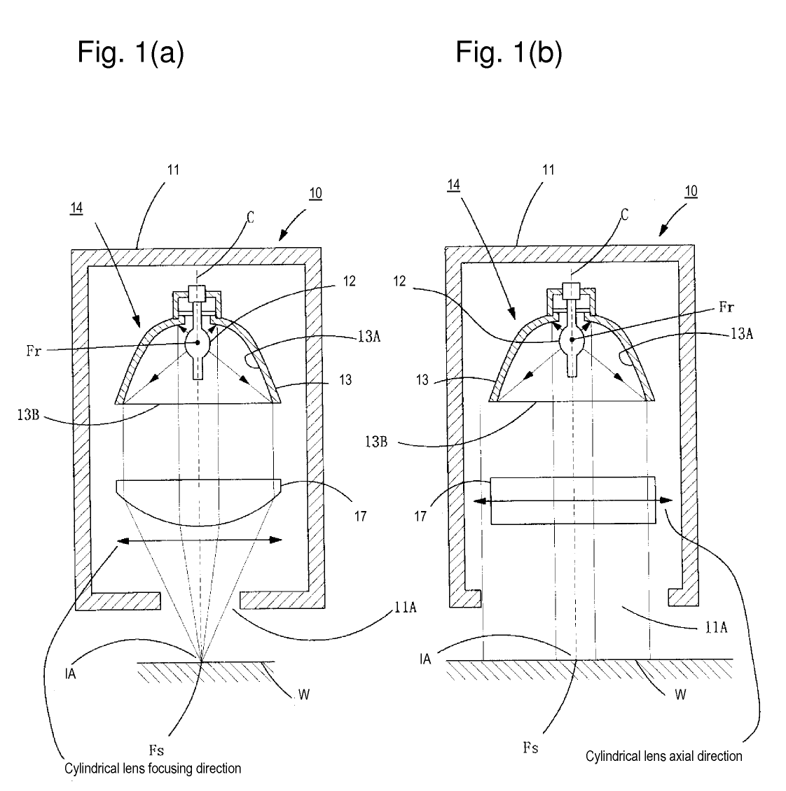

FIGS. 1(a) & 1(b) are cross sections showing the basic constitution of the light irradiation device of this invention; FIG. 1(a) is a cross section as seen from the axial direction of the cylindrical lens, and FIG. 1(b) is a cross section as seen from the focusing direction of the cylindrical lens.

This light irradiation device 10 has, for example, a box-shaped outer cover 11, that has a light-output opening 11A that opens in one direction (downward in FIG. 1(a)). A light source 14 that comprises short-arc type discharge lamp 12 and a reflector 13 that surrounds the discharge lamp 12 and reflects the light emitted by the discharge lamp 12 is located within the outer cover 11. There is also a cylindrical lens 17 that focuses the light from the light source 14 in only a uniaxial direction and emits it to the outside through the light-output opening 11A.

In the example shown in FIGS. 1(a) & 1(b), the reflector 13 of the light source 14 comprises a parabolic mirror with a reflecting surface 13A that is a paraboloid of revolution centered on the optical axis C; it is placed so that the irradiation opening 13B of the reflector 13 opens downward in FIGS. 1(a) & 1(b), facing the light-output opening 11A of the light irradiation device 10, with the optical axis C perpendicular to the light irradiation surface W.

The discharge lamp 12 of the light source 14 is, for example, an ultra-high pressure mercury lamp that efficiently radiates ultraviolet light with a wavelength of 300 to 450 nm; it comprises a pair of electrodes facing across an inter-electrode gap of 0.5 to 2.0 mm within the discharge vessel into which are sealed specified amounts of mercury, which is the light-emitting substance, a rare gas, which is a buffer gas to assist start-up, and halogen. The sealed amount of mercury here is from 0.08 to 0.30 mg/mm³, for example.

The discharge lamp 12 has the emission point of the discharge lamp (the arc spot, for example) placed at the focal point Fr of the reflector 13, so that a straight line connecting the pair of electrodes extends along the optical axis C.

The cylindrical lens 17 focuses the incident light reflected by the reflector 13 in only a uniaxial direction at the focal point Fs of the cylindrical lens 17. The focal point Fs is positioned on the light irradiation surface W and is placed to extend along the light irradiation surface W (in FIG. 1(a), this is the direction perpendicular to the plane of the drawing).

In this light irradiation device 10, the light emitted from the discharge lamp 12 is reflected by the reflector 13 that has a reflecting surface 13A that is a paraboloid of revolution and is converted to collimated light along the optical axis C that is irradiated toward the cylindrical lens 17 by way of the irradiation opening 13B; the collimated light incident on the cylindrical lens 17, as shown in FIG. 1(b), remains collimated and is not focused in the axial direction of the cylindrical lens 17, but is output by way of the light-output opening 11A while focused only in the direction perpendicular to the axial direction of the cylindrical lens 17 (in FIG. 1(a), this is the direction to the left and right of the figure). Thus, a light irradiation zone IA that extends linearly in the axial direction of the cylindrical lens 17 is formed on the light irradiation surface W at the position of the focal point Fs of the cylindrical lens 17.

The light irradiation device 10, constituted in this way, is structured with an optical system that combines a reflector 13 and a cylindrical lens 17, using a short-arc type discharge lamp 12 as the light-source lamp. By this means, the light from the discharge lamp 12, which forms a point light source, can be focused to extend linearly on the light irradiation surface W in the axial direction of the cylindrical lens 17, while the light irradiation zone IA formed on the light irradiation surface W is kept from spreading, and so it is possible to use the light from the discharge lamp 12 efficiently. Moreover, the discharge lamp 12, itself, is of high radiance, and so the linear light irradiation zone IA formed on the light irradiation surface W has a high peak irradiance.

The discharge lamp 12 here is placed with a straight line connecting the pair of electrodes falling along the optical axis C of the reflector 13, and an electrode is set in the portion of the discharge lamp 12 directed at the opening of the reflector 13. For that reason, most of the light radiated from the discharge lamp 12 does not irradiate the light irradiation surface W, but is reflected by the reflector 13.

Accordingly, it is possible to use as the reflector described below, for example, a cold mirror with vapor deposition of multiple layers. Such a mirror functions to allow light from the visible through infrared region and thermal radiation from the lamp to pass through, reflecting only ultraviolet light. Thus, irradiation of the light irradiation surface by light from the visible through infrared region included in the light radiated by the discharge lamp is prevented, along with an associated temperature rise on the light irradiation surface.

In the light irradiation device shown in FIG. 1, the cylindrical lens 17 located on the light-output side of the reflector 13 must have a length in its focusing direction that is equal to or greater than the measurement of the light path (radiant flux), so that the light output from the reflector 13 (the light reflected by the reflector) will all be incident on the cylindrical lens 17. Because the cylindrical lens is made of glass, however, the larger it is the greater its weight will be. As the weight increases, it becomes more of a disadvantage for moving the light irradiation device at high speeds, when mounted in an inkjet printer, for example.

Therefore, it is desirable that the cylindrical lens be as small as possible to lighten the weight of the light irradiation device.

The embodiment explained below has a smaller cylindrical lens in the light irradiation device shown in FIG. 1(a) & 1(b), and the weight of the light irradiation device is reduced.

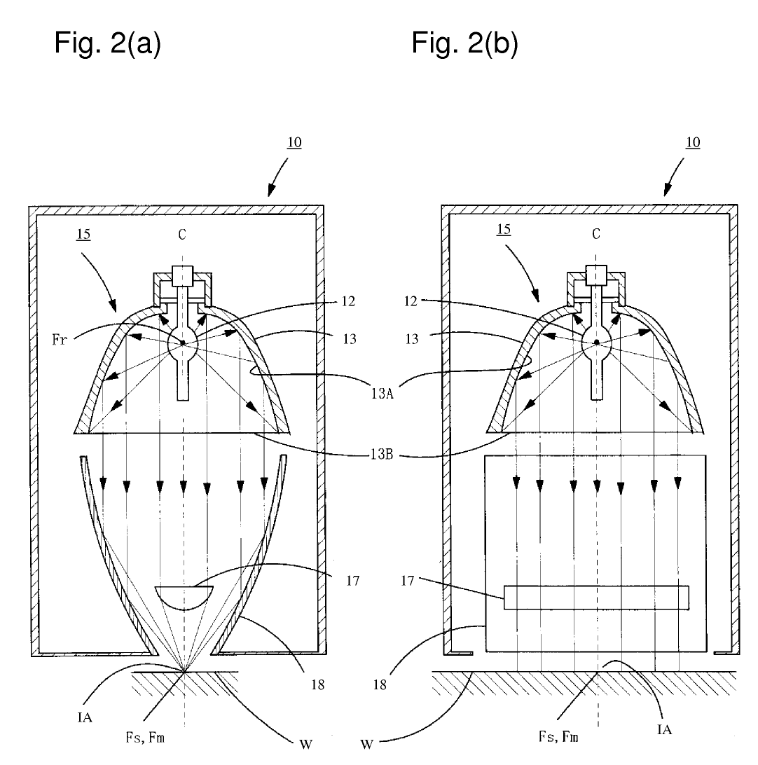

FIG. 2 shows an example of the light irradiation device of a first embodiment of this invention; FIG. 2(a) is a cross section as seen from the axial direction of the cylindrical lens, and FIG. 2(b) is a cross section as seen from the focusing direction of the cylindrical lens.

The constitution of the light source 15 is the same as in FIG. 1, and the reflector 13 in the light source 15 comprises a parabolic mirror with a reflecting surface 13A that is a paraboloid of revolution centered on the optical axis C; it is placed so that the irradiation opening 13B of the reflector 13 opens to face the light-output opening 11A of the light irradiation device 10, with the optical axis C perpendicular to the light irradiation surface W.

The discharge lamp 12 in the constitution of the light source 15 is, for example, an ultra-high pressure mercury lamp as described above; its emission point (the arc spot, for example) placed at the focal point Fr of the reflector 13, so that a straight line connecting the pair of electrodes extends along the optical axis C.

As shown in FIGS. 2(a) & 2(b), the light source of this embodiment has, on the light-output side of the reflector, barrel-shaped reflecting mirrors 18 that have cylindrical reflecting surfaces that are parabolic in cross section (the cross section in the first direction is parabolic and the cross in the direction perpendicular to the first direction is a straight line; also called “cylindrical/parabolic mirrors” hereafter).

These reflecting mirrors 18 are placed on both sides of the cylindrical lens 17 so that their axial direction is parallel to the axial direction of the cylindrical lens 17, and is located so as to focus linearly on the light irradiation surface at the focusing position of the cylindrical lens 17.

In this light irradiation device, the light emitted from the discharge lamp 12 is reflected by the reflector 13 that has a reflecting surface 13A that is a paraboloid of revolution and converted to collimated light along the optical axis C.

The emitted light can be divided into that which is incident on the cylindrical lens 17 and that reflected by the reflecting mirrors 18.

As explained relative to FIGS. 1(a) & 1(b) above, the collimated light incident on the cylindrical lens 17 remains collimated and is not focused in the axial direction of the cylindrical lens 17, but is output while focused only in the direction perpendicular to the axial direction of the cylindrical lens 17. Thus, a light irradiation zone that extends linearly in the axial direction of the cylindrical lens 17 is formed on the light irradiation surface at the position of the focal point Fs of the cylindrical lens 17.

The collimated light incident on the reflecting mirrors 18, on the other hand, as in the case of the cylindrical lens, remains collimated and is not focused in the axial direction of the barrel-shaped reflecting mirrors, but is output while focused only in the direction perpendicular to the axial direction of the reflecting mirrors. Thus, a light irradiation zone that extends linearly in the axial direction of the mirrors is formed on the light irradiation surface at the position of the focal point Fm of the reflecting mirrors 18.

If the axial direction of the reflecting mirrors here is placed to be parallel to the axial direction of the cylindrical lens 17 and the focal point Fm of the reflecting mirrors 18 matches the focal point Fs of the cylindrical lens 17 on the light irradiation surface, the light irradiation zone formed by the reflecting mirrors 18 will be irradiated overlapping the light irradiation zone formed by the cylindrical lens 17.

The reflecting mirrors 18 placed on the light-output side of the reflector 13 are made of aluminum sheet material, for example, and so they are far lighter that the cylindrical lens 17, which is a glass lens. For that reason, even though there is an increase of two reflecting mirrors from what is shown in FIG. 1, the cylindrical lens 17 becomes that much smaller and lighter. When constituted as this embodiment, therefore, when considered in terms of the light irradiation device as a whole, it can be made lighter than that shown in FIG. 1.

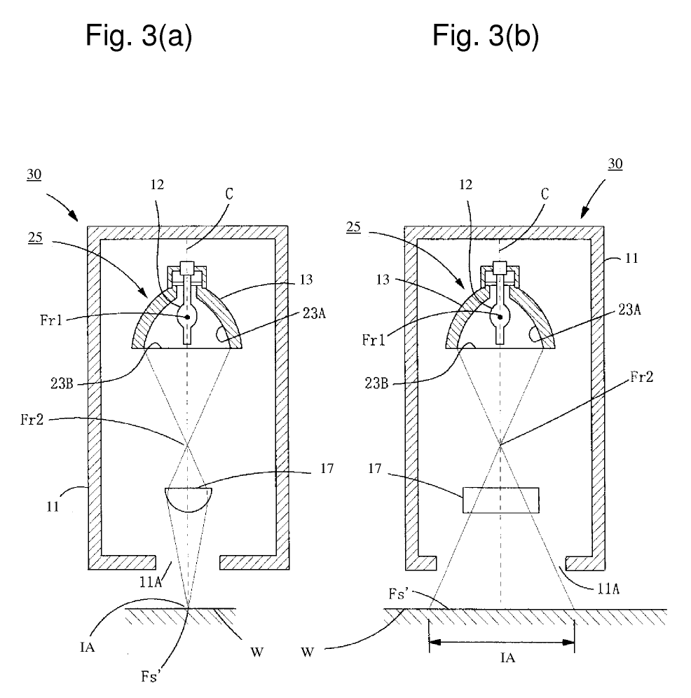

FIGS. 3(a) & 3(b) show an example of constitution of the light irradiation device of the second embodiment of this invention; FIG. 3(a) is a cross section as seen from the axial direction of the cylindrical lens, and FIG. 3(b) is a cross section as seen from the focusing direction of the cylindrical lens.

For the reflector of the light irradiation device of the second embodiment of this invention, the parabolic mirror used in the light irradiation device shown in FIGS. 1(a) & 1(b) is replaced with an elliptical condensing mirror that has a reflecting surface 23A that is an ellipsoid of revolution centered on the optical axis C; otherwise the basic constitution is the same as that of the light irradiation device 10 shown in FIG. 1.

That is, as shown in FIG. 3, a light source 25 that has a short-arc type discharge lamp 12 and a reflector 23 that surrounds the discharge lamp 12 and reflects the light from the discharge lamp 12 is located within an outer cover 11 that has a light-output opening 11A that opens in one direction (downward in FIGS. 3(a) & 3(b)). There is also a cylindrical lens 17 in order to focus the incident light from the light source 25 only in a uniaxial direction and output it to the outside, by way of the light-output opening 11A.

The reflector 23 in the constitution of the light source 25 uses an elliptical condensing mirror having a reflecting surface 23A that is an ellipsoid of revolution centered on the optical axis C.

The discharge lamp 12 in the constitution of the light source 25 has the same constitution as that in the first embodiment; its emission point (the arc spot, for example) placed at the first focal point Fr1 of the reflecting surface 23A that is an ellipsoid of revolution in the reflector 23, so that a straight line connecting the pair of electrodes extends along the optical axis C of the reflector 23.

The cylindrical lens 17 focuses, only in a uniaxial direction, the incident light reflected by the reflector 23 at the focusing point Fs' of the cylindrical lens 17. The focusing point Fs' is positioned on the light irradiation surface W and is placed so that it extends along the light irradiation surface W (the direction perpendicular to the plane of the drawing in FIG. 3(a), and the right and left direction in FIG. 3(b)).

In this light irradiation device 30, the light radiated by the discharge lamp 12 is reflected by the reflector 23 that has a reflecting surface 23 that is an ellipsoid of revolution, and is focused at the second focal point Fr2 of the reflecting surface 23A that is an ellipsoid of revolution of the reflector 23, by way of the irradiation opening 23B. Once the light is focused at the second focal point Fr2, it spreads until it becomes incident in the cylindrical lens 17.

The light that is incident in the cylindrical lens 17 is output by way of the light-output opening while spreading without being focused in the axial direction of the cylindrical lens 17 (see, FIG. 3(b)) and while being focused in the direction perpendicular to the axial direction of the cylindrical lens 17 (see, FIG. 3(a)), and thus, forms a light irradiation zone IA that extends linearly, in the axial direction of the cylindrical lens 17, on the light irradiation surface W at the position of the focusing point Fs' of the cylindrical lens.

The following effects can be obtained with the optical system that combines a reflector 23 that is an elliptical mirror with a reflecting surface that is an ellipsoid of revolution with a cylindrical lens 17 and irradiates with linearly focused light from the discharge lamp 12.

The angle of spread of light that has been focused at the second focal point Fr2 of the reflector 23 can be set on the basis of the curvature of the reflector 23, and the focusing position (distance from the focal point) of the light to be focused by the cylindrical lens 17 can be set on the basis of the curvature of the cylindrical lens 17. Therefore, by adjusting the curvature of the reflector 23 and the curvature of the cylindrical lens 17, it is possible to appropriately adjust, depending on the object, the length of the linearly extending light irradiation zone IA.

Further, using an elliptical condensing mirror as the reflector 23 reduces the diameter of the light beam. Therefore, it is possible to reduce the size of the cylindrical lens 17. Accordingly, the light irradiation device as a whole can be made lighter than that shown in FIGS. 1(a) & 1(b), and this has the advantage of enabling faster movement when used as the light source of an inkjet printer, for example.

The explanations above concern a light irradiation device in which there is a single light source. However, in order to obtain a light irradiation zone of appropriate size (length) relative to the size of the article to be irradiated, the use of multiple light sources is also possible. As an example of the use of multiple light sources, a light irradiation device that has two light sources is explained below.

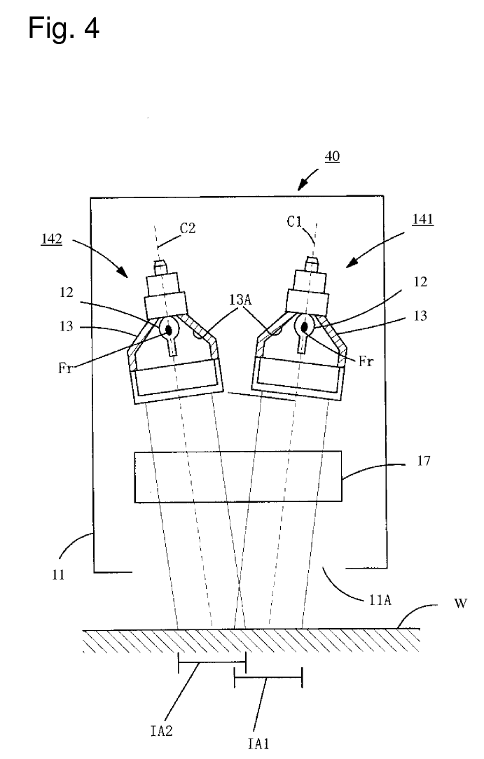

FIG. 4 is a cross section showing the first example of constitution of a light irradiation device having two of the light sources shown in FIG. 1(a) & 1(b); the Figure is a cross section as seen from the focusing direction of the cylindrical lens.

This light irradiation device 40 has an outer cover 11 that has a light-output opening 11A that opens in one direction (downward in FIG. 4). Two light sources 141, 142, each have a short-arc type discharge lamp 12 and a reflector 13 that surrounds the discharge lamp 12 and reflects the light from the discharge lamp 12, within the outer cover 11.

The light sources 141, 142 have the same constitution as the light source 14 shown in FIGS. 1(a) & 1(b); the reflector 13 is constituted as a parabolic mirror having a reflecting surface 13A that is a paraboloid of revolution centered on the optical axis C1, and the discharge lamp 12 explained in FIGS. 1(a) & 1(b) is positioned with its light-emitting portion (the arc spot, for example) placed at the focal point Fr of the paraboloid of revolution reflecting surface 13A of the reflector 13, so that straight lines connecting the paired electrodes extend along the optical axes C1, C2.

The light sources 141, 142 are inclined toward each other so that the light irradiation zone IA1 and the light irradiation zone 142 are not disconnected on the light irradiation surface W, but overlap at their ends.

The light emitted from the light sources 141, 142 is incident on a single cylindrical lens 17; it is focused in a uniaxial direction and is linearly focused at the focal point Fs on the light irradiation surface W.

In this light irradiation device 40, the light emitted from the discharge lamps 12 in the light sources 141, 142 is reflected by the reflector 13 and converted to collimated light along the optical axes C1, C2 and irradiated toward the cylindrical lens 17; the collimated light incident on the cylindrical lens 17 remains collimated and is not focused in the axial direction of the cylindrical lens 17 (the right/left direction in FIG. 4), but is output by way of the light-output opening 11A while focused only in the direction perpendicular to the axial direction of the cylindrical lens 17 (the direction perpendicular to the plane of FIG. 4). Thus portions (the end portions) of the light irradiation zones IA1, IA2 of the light sources 141, 142 that extend linearly in the axial direction of the cylindrical lens 17 overlap on the light irradiation surface W at the position of the focal point Fs of the cylindrical lens 17.

With the light irradiation device 40 with the constitution described above, in the light irradiation zones IA1, IA2 of the light sources 141, 142 that are formed to extend linearly on the light irradiation surface W the ends of each light irradiation zone has lower irradiance than the central portion, but by overlapping them, their irradiance is added and is equivalent to the irradiance of the central portion. Accordingly, in the light irradiation zones it is possible to set a large effective zone that has irradiance that is high enough, and to reliably obtain a light irradiation zone of a size suited to the purpose.

Now, the explanation above has taken the example of the light irradiation device shown in FIG. 1, but the same constitution of multiple light sources is possible with the light irradiation devices shown in FIGS. 2 and 3 as well; such constitutions make it possible to obtain the same effects described above.

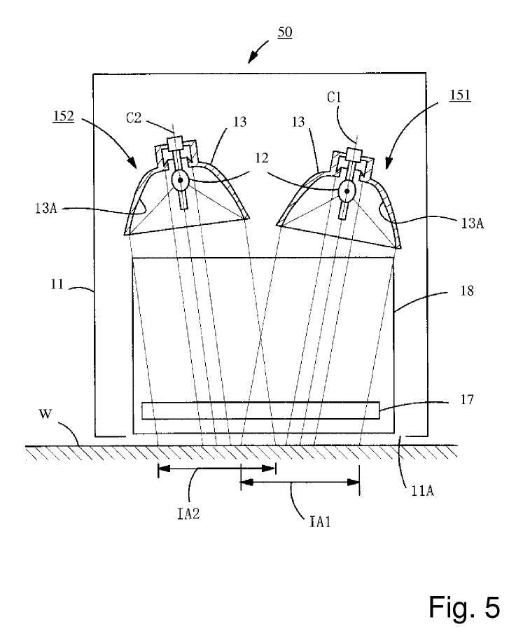

FIG. 5 is a cross section showing the second example of constitution of a light irradiation device having two of the light sources shown in FIG. 2; the Figure is a cross section as seen from the focusing direction of the cylindrical lens.

This light irradiation device 50 has an outer cover 11 that has a light-output opening 11A that opens in one direction (downward in FIG. 4). Two light sources 151, 152, each having a short-arc type discharge lamp 12 and a reflector 13 that surrounds the discharge lamp 12 and reflects the light from the discharge lamp 12, are located within the outer cover 11.

The light sources 151, 152 have the same constitution as the light source 15 shown in FIG. 2; the reflector 13 is constituted as a parabolic mirror having a reflecting surface 13A that is a paraboloid of revolution centered on the optical axis C1, and the discharge lamp 12 explained in FIGS. 1(a) & 1(b) is positioned with its light-emitting portion (the arc spot, for example) placed at the focal point Fr of the paraboloid of revolution reflecting surface 13A of the reflector 13, so that straight lines connecting the paired electrodes extend along the optical axes C1, C2.

The light sources 151, 152 are inclined toward each other so that the light irradiation zone IA1 and the light irradiation zone 142 are not disconnected on the light irradiation surface W, but overlap at their ends.

On the light-output side of the reflectors 13 of the two light sources 11, 12 are barrel-shaped reflecting mirrors 18 that have cylindrical reflecting surfaces of which the cross section is parabolic, as shown in FIG. 2 (only one pair of reflecting mirrors is shown in the figure, but reflecting mirrors 18 can also be placed on this side of the cylindrical lens 17).

As shown in FIG. 2(a), the reflecting mirrors 81 are placed on two sides of the cylindrical lens 17 so that their axial directions are parallel to the axial direction of the cylindrical lens 17 so that they focus linearly on the light irradiation surface at the focusing position of the cylindrical lens 17.

In FIG. 5, the light emitted from the light sources 151, 152 is incident on a single cylindrical lens 17; it is focused in a uniaxial direction and is linearly focused at the focal point Fs on the light irradiation surface W.

Further, the light incident on the reflecting mirrors 18 is output while focused only in the direction perpendicular to the axial direction of the reflecting mirrors, and is focused linearly, in the axial direction of the mirrors, on the light irradiation surface at the position of the focal point Fm of the reflecting mirrors 18.

If the axial direction of the reflecting mirrors here is placed to be parallel to the axial direction of the cylindrical lens 17 and the focal point Fm of the reflecting mirrors 18 matches the focal point Fs of the cylindrical lens 17 on the light irradiation surface, the light irradiation zone formed by the reflecting mirrors 18 will be irradiated overlapping the light irradiation zone formed by the cylindrical lens 17.

Thus, portions (the end portions) of the light irradiation zones IA1, IA2 of the light sources 151, 152 that extend linearly overlap.

With the light irradiation device 50 having the constitution described above, in the light irradiation zones IA1, IA2 of the light sources 151, 152 that are formed to extend linearly on the light irradiation surface W, the ends of each light irradiation zone has lower irradiance than the central portion, but by overlapping them, their irradiance is added and is equivalent to the irradiance of the central portion. Accordingly, in the light irradiation zones, it is possible to set a large effective zone that has irradiance that is high enough, and to reliably obtain a light irradiation zone of a size suited to the purpose.

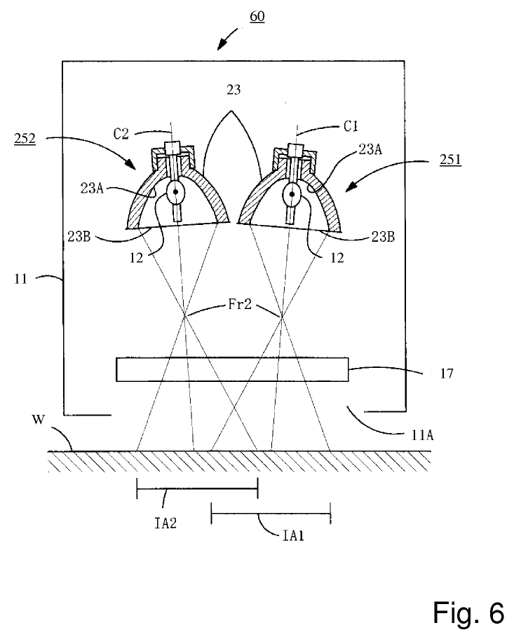

FIG. 6 is a cross section showing the third example of constitution of a light irradiation device having two of the light sources shown in FIG. 3; the figure is a cross section as seen from the focusing direction of the cylindrical lens.

This light irradiation device 60 has an outer cover 11 that has a light-output opening 11A. Two light sources 251, 252, each have a short-arc type discharge lamp 12 and a reflector 13 that surrounds the discharge lamp 12 and reflects the light from the discharge lamp 12, are located within the outer cover 11.

The light sources 251, 252 are inclined toward each other so that the light irradiation zone IA1 and the light irradiation zone 142 are not disconnected on the light irradiation surface W, but overlap at their ends.

The light sources 251, 252 have the same constitution as the light source 25 shown in FIG. 3; the reflectors in the constitution of the light sources 251, 252 are elliptical mirrors that have reflecting surfaces 23A that are ellipsoids of revolution centered on the optical axis C.

The discharge lamps 12 in the constitution of the light sources 251, 252 have the same constitution as that shown in FIG. 3; their light-emitting portions (the arc spots, for example) placed at the first focal points Fr1 of the reflecting surfaces 23A that are ellipsoids of revolution in the reflectors 23, so that a straight line connecting the pair of electrodes extends along the optical axis C of the reflector 23.

The cylindrical lens 17 focuses, only in a uniaxial direction, the incident light reflected by the reflector 23 at the focusing point Fs' of the cylindrical lens 17. The focusing point Fs' is positioned on the light irradiation surface W and is placed so that it extends along the light irradiation surface W.

In FIG. 6, the light radiated by the discharge lamp 12 is reflected by the reflector 23 that has a reflecting surface 23 that is an ellipsoid of revolution, and is focused at the second focal point Fr2 of the reflecting surface 23A that is an ellipsoid of revolution of the reflector 23, by way of the irradiation opening 23B. Once the light is focused at the second focal point Fr2, it spreads till it becomes incident on the cylindrical lens 17.

The light that is incident on the cylindrical lens 17 is output by way of the light-output opening while being focused in the direction perpendicular to the axial direction of the cylindrical lens 17, and thus forms light irradiation zones IA1, IA2 that extend linearly, in the axial direction of the cylindrical lens 17, on the light irradiation surface W at the position of the focusing point Fs' of the cylindrical lens.

Thus, portions (the end portions) of the light irradiation zones IA1, IA2 of the light sources 251, 252 that extend linearly overlap.

In the light irradiation device shown in FIG. 6, in particular, the length of the light irradiation zones formed to extend linearly can be adjusted as appropriate to the purpose, and the irradiance of the end portions, which is lower than that of the center portion, can be complemented as the size of the zone overlap is adjusted. Accordingly, it is possible to bring about easily an irradiance distribution that is uniform in the axial direction of the light irradiation zones, and possible to overlap the end portions of the light irradiation zones of two or more adjacent light sources without inclining their optical axes relative to the light irradiation surface, and so design of equipment structure is simplified.

Now, cases in which two light sources are used are shown in FIGS. 4 through 6, but three or more light sources may be used in the event that a longer light irradiation zone is to be obtained.

Here, the shape of the light irradiation zone when two or more light sources are used can be a straight line in which there are overlaps of at least a portion of the light irradiation zones of adjacent light sources, but they do not necessarily have to be lined up straight for application to inkjet printers.

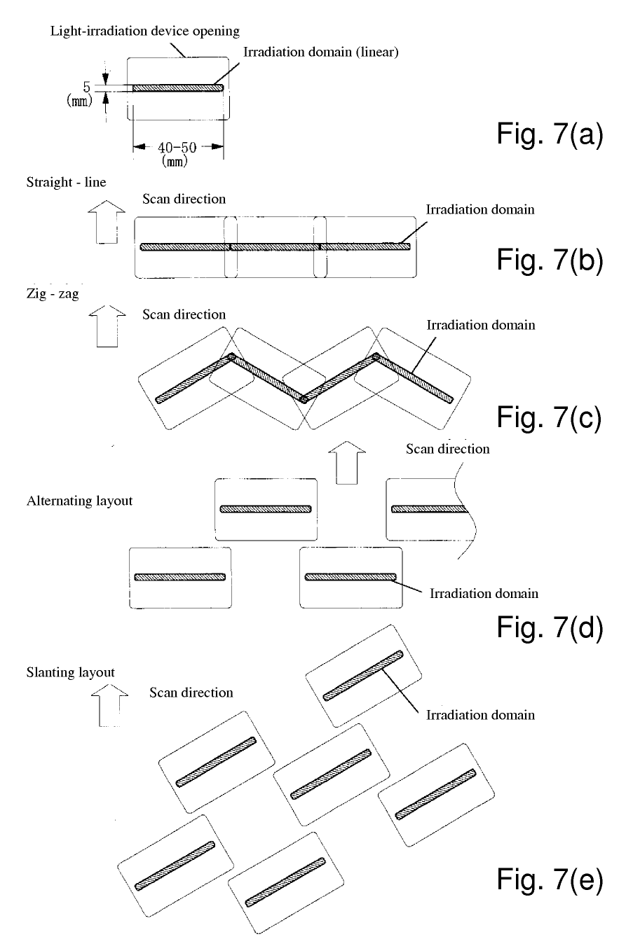

Examples of shapes of light irradiation zones are shown in FIGS. 7(a)-7(e). The large arrows in these figures show the scanning direction of the light irradiation portion when applied to an inkjet printer.

FIG. 7(a) shows the shape of the light irradiation region when a single light source is used, FIG. 7(b) shows the light irradiation regions arranged in a straight line, FIG. 7(c) shows the light irradiation regions arranged in a zig-zag shape, FIG. 7(d) shows the light irradiation regions arranged alternately in parallel lines, and FIG. 7(e) shows the light irradiation regions arranged alternately in parallel lines that are obliquely angled relative to the scanning direction.

In FIGS. 7(b) & 7(c), there is a partial overlap of light irradiation regions, but a partial overlap of light irradiation regions is not really necessary; in FIG. 7(c) & 7(d), at least parts of the light irradiation regions overlap with respect to the direction perpendicular to the light source layout (the scanning direction in the figures).

The light irradiation regions formed by the light sources of this invention to extend in a line have lower irradiance at the ends of the region than in the center, but in this embodiment, the end regions with lower irradiance than the center regions overlap each other, and so the irradiance of the end regions is augmented and is the same as the irradiance of the center regions.

In the light-irradiated regions, therefore, it is possible to set a large effective region that has adequately high irradiance, and it is possible to reliably obtain a light irradiation region of a size suited to the purpose.

In the light irradiation device of this invention, as described above, it is possible to use reflectors having multiple layers of vapor deposition with the function of allowing light in the visible and infrared regions and thermal radiation from the lamps to pass through, while reflecting only the ultraviolet light (cold mirrors). In the event of such a constitution, when a light irradiation device as described above is applied to an inkjet printer using light-curable inks, for example, it is possible to prevent more reliably the irradiation of the substrate by the infrared and visible light that is included in the light emitted from the discharge lamps, but is not needed for curing the ink, or the thermal radiation from the arc tube of the lamps that increase in temperature when the discharge lamps are lit. Because of this, it is possible to prevent heating of the substrate (raising the substrate to a high temperature) and consequently it is very useful in the event that a paper, polymer, or film that is easily deformed by heat is used as the substrate.

Moreover, the short-arc type discharge lamp is not limited to an ultra-high-pressure mercury lamp; it is possible to use a metal halide short-arc type discharge lamp, for example. If a halogen compound of iron (Fe) is sealed in, in particular, the efficiency of light emission in the wavelength range of 350 to 450 nm increases, and so it is possible to increase the total discharge flux in the light irradiation area and thus to improve the efficiency of the curing process for light-curable ink, for example.

As stated above, by means of the light irradiation device of this invention, the light from a short-arc type discharge lamp that forms a point light source can be focused to extend linearly on the light irradiation surface while preventing the spread of the light irradiation zone on the light irradiation surface, and so it is possible to use the light from the discharge lamp more efficiently. Moreover, the short-arc type discharge lamp is of high radiance, and so the light irradiation zone formed on the light irradiation surface is linear with an effective zone of the specified size that has high peak irradiance. Accordingly, the light irradiation device of this invention is very useful when applied as the light source in, for example, a light-cure inkjet printer (simply called an “inkjet printer” hereafter).

By means of the constitutions in FIGS. 2 & 3, especially, it is possible to lighten the light irradiation device, and so it is possible both to lighten the inkjet printer as a whole and to increase the printing speed and the speed of pattern formation.

(2) Application to Inkjet Printers

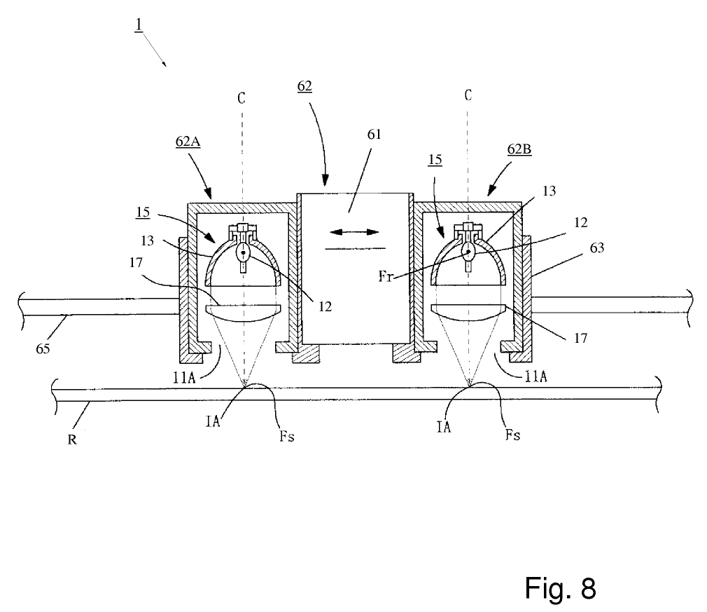

FIG. 8 is a cross section that shows schematically the constitution when the light irradiation devices shown in FIGS. 1(a) & 1(b) are applied to the head portion of an inkjet printer. Now, the example of an inkjet printer used for printing images is explained below, but it can be applied in the same way to the formation of patterns, such as circuit patterns.

This inkjet printer 1 has an inkjet head 61 fitted with nozzles (not illustrated) that eject fine droplets of, for example, a liquid ink curable by ultraviolet radiation, and two light irradiation devices 62A, 62B that are located on both sides, for example, of the inkjet head 61 and that cure the ink, which is the liquid material that has impacted a substrate R, by irradiating it with ultraviolet light; these are part of the head portion 62 that is mounted on a carriage 63.

The head portion 62 is supported by a bar-shaped guide rail 65 that is placed to extend along the substrate R, and can be moved by a drive mechanism (not shown) back and forth along the guide rail 65 above the substrate R.

Such inks as radical polymer ink that includes a radical-polymerizable compound as the polymerization compound or a cation polymer ink that includes a cation-polymerizable compound as the polymerization compound, for example, can be used as the ultraviolet light-curable ink. Now, when an inkjet printer is used to form patterns, such as circuit patterns, something like a resist ink that includes a light-polymerizable compound is used as the liquid material ejected from the inkjet head.

Such things as paper, resin, film, or print board can be used as the substrate R.

The light irradiation devices 62A, 62B shown in FIG. 8 comprise light irradiation devices with the same constitution as the light irradiation device 40 shown in FIG. 1, with two light sources lined up together. That is, the light source 15 has a reflector 13 that is comprised of a parabolic mirror that has a reflective surface 13a that is a paraboloid of revolution centered on the optical axis C and a cylindrical lens 17 that linearly focuses incident light reflected by the reflector 13. Then, the discharge lamp 12 has its light-emitting portion (the arc spot, for example) placed at the focal point Fr of the paraboloid of revolution of the reflector 13, so that a straight line connecting the pair of electrodes extends along the optical axis C.

Now, when a longer linear light irradiation zone is desired, light sources can be lined up as shown in FIG. 4.

In this inkjet printer, the head portion 60 that is located so that the substrate R is positioned at or in the vicinity of the position of the focal point Fs of the cylindrical lenses 17 in the light irradiation devices 62A, 62B moves while the discharge lamps 12 are lit; by this means, the light from the discharge lamps 12 is linearly focused in the direction perpendicular to the direction of travel of the head portion 62 (in the direction perpendicular to the surface of the paper in FIG. 8) and irradiates the substrate R, by which means the ultraviolet light-curable ink is cured immediately after impacting the substrate R.

To explain more concretely the process of curing ultraviolet light-curable inks, when the printing is performed as the head portion 62 moves to the right in FIG. 8, the ultraviolet light-curable ink that impacts the substrate R is cured by light irradiated by the light irradiation device 62A that is positioned to the rear in the direction of travel of the head portion 62. When, on the other hand, the printing is performed as the head portion 62 moves to the left in FIG. 8, the ultraviolet light-curable ink that impacts the substrate R is cured by light irradiated by the light irradiation device 62B that is positioned to the rear in the direction of travel of the head portion 62.

With an inkjet printer having this construction, light with a high peak irradiance from short-arc type discharge lamps 12 of high radiance irradiates the ultraviolet light-curable ink that has impacted the substrate R, and so it can cure (polymerize) the ultraviolet light-curable ink quickly after it impacts the substrate R and can shorten the time needed for curing. Accordingly, it is possible to prevent changes in the dot shape, and thus possible to reliably form high-quality images and circuit patterns and other patterns.

Moreover, by means of a structure in which the light irradiation devices 62A, 62B irradiate the substrate R with light from the discharge lamps 12 that has been reflected by the reflectors 13, it is possible to prevent the direct incidence on the substrate R of light in the visible through infrared regions included in the light radiated from the discharge lamp and thermal radiation that accompanies the lighting of the discharge lamp. Accordingly, it is possible to minimize the effect of heat on the substrate R, and to reliably prevent deformation of the substrate even when using a substrate that is easily deformed by heat. Accordingly, constraints on the substrates R that can be used are removed.

In accordance with this invention, moreover, the light irradiation device (lighting fixture) can be made smaller and lighter than those equipped with long-arc type discharge lamps, and so it is possible to reduce the overall weight of the inkjet printer, and also to increase the print speed or pattern formation speed by improving curing efficiency of light-curable liquid materials.

Further, with this invention, it is possible to apply to the inkjet printer the light irradiation devices of FIGS. 2 & 3, not just the light irradiation device shown in FIG. 1.

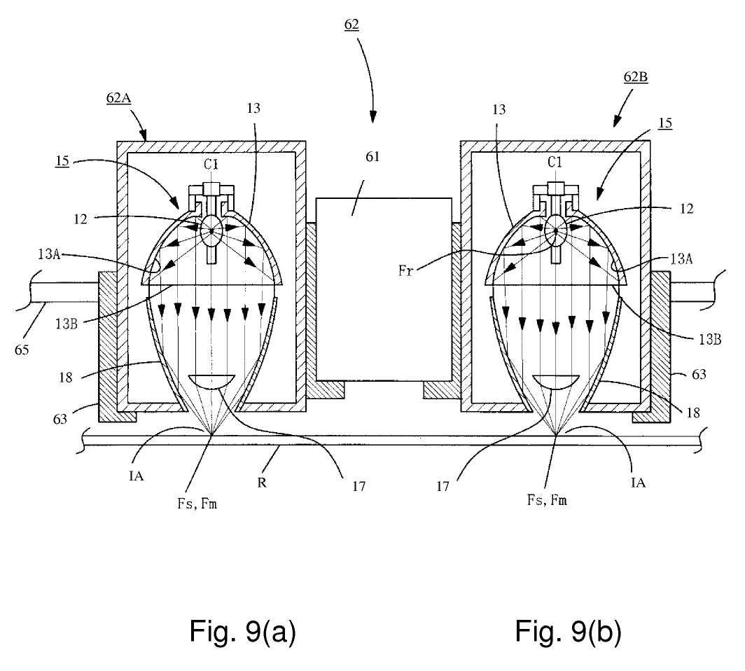

FIG. 9 shows an example of an inkjet printer using the light irradiation device shown in FIG. 2.

As stated previously, two light irradiation devices 62A, 62B are located on both sides of an inkjet head 61 fitted with nozzles that eject ultraviolet light-curable ink onto a substrate R; these are mounted on a carriage 63. This head portion 62 is supported by a bar-shaped guide rail 65 that is placed to extend along the substrate R, and can be moved back and forth along the guide rail 65 above the substrate R to the right and the left in the figure.

The light irradiation devices 62A, 62B in FIG. 9 comprise two light sources having the same construction as the light irradiation device 50 shown in FIG. 2.

That is, the reflector 13 comprises a parabolic mirror that has a reflecting surface that is a paraboloid of revolution centered on the optical axis C1, and the light-emitting portion of the discharge lamp (the arc spot, for example) is placed at the focal point Fr of the paraboloid of revolution reflecting surface 13A of the reflector 13, so that a straight line connecting the pair of electrodes extends along the optical axis C.

On the light-output side of the reflector 13 there are a cylindrical lens 17 and barrel-shaped reflecting mirrors 18 that have cylindrical reflecting surfaces that are parabolic in cross section, placed on two sides of the cylindrical lens 17 so that their axial directions are parallel to the axial direction of the cylindrical lens 17 and located so that they linearly focus on the light irradiation surface at the focusing position of the cylindrical lens 17.

Now, when a longer linear light irradiation zone is desired, light sources can be lined up as shown in FIG. 5.

In this inkjet printer, the head portion 62 is located so that the substrate R is positioned at or in the vicinity of the position of the focal point Fs of the cylindrical lenses 17 and the position of the focal point Fm of the reflecting mirrors 18 in the light irradiation devices 62A, 62B moves while the discharge lamps 12 are lit; by this means, the light from the discharge lamps 12 is linearly focused in the direction perpendicular to the direction of travel of the head portion 62 (in the direction perpendicular to the surface of the paper in FIG. 9) and irradiates the substrate R, by which means the ultraviolet light-curable ink is cured immediately after impacting the substrate R.

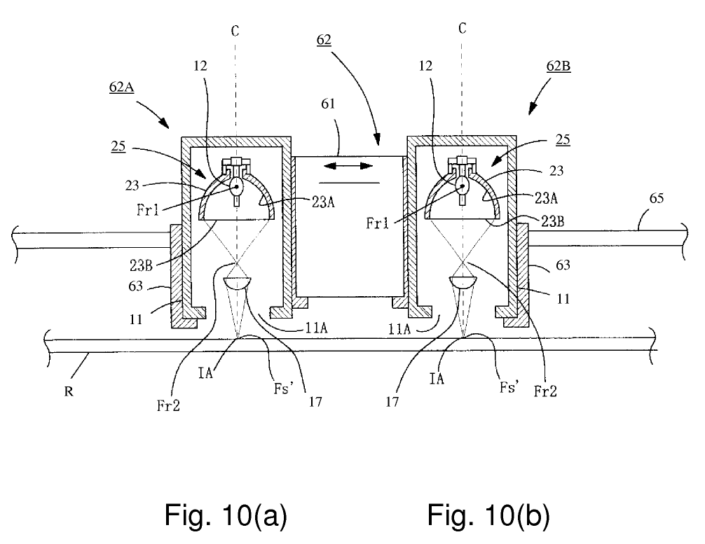

FIGS. 10(a) & 10(b) show an example of an inkjet printer using the light irradiation device shown in FIG. 3.

As stated previously, two light irradiation devices 62A, 62B are located on both sides of an inkjet head 61 fitted with nozzles that eject ultraviolet light-curable ink onto a substrate R; these are mounted on a carriage 63. This head portion 62 is supported by a bar-shaped guide rail 65 that is placed to extend along the substrate R, and can be moved back and forth along the guide rail 65 above the substrate R, to the right and the left in the figure.

The light irradiation devices 62A, 62B in FIG. 10 are constructed in the same manner as the two light sources of the light irradiation device 50 shown in FIG. 3. That is, the reflectors 23 of the light sources 25 use elliptical condensing mirrors that have reflecting surfaces that are ellipsoids of revolution centered on the optical axes C. The discharge lamps 12 have the same construction shown in FIGS. 1(a) & 1(b) and their light emitting portions (the arc spots, for example) are placed at the focal points Fr1 of the ellipsoid of revolution reflecting surfaces 23A of the reflectors 13, so that the straight line connecting each pair of electrodes extends along the optical axis C.

The cylindrical lens 17 focuses, only in a uniaxial direction, the incident light reflected by the reflector 23 at the focusing point Fs' of the cylindrical lens 17. The focusing point Fs' is positioned on the light irradiation surface W and is placed so that it extends along the light irradiation surface W so that the light radiated by the discharge lamp 12 is reflected by the reflector 23 and is focused at the second focal point Fr2 of the reflecting surface 23A that is an ellipsoid of revolution of the reflector 23.

Once the light is focused at the second focal point Fr2, it spreads till it becomes incident on the cylindrical lens 17; the light that is incident on the cylindrical lens 17 is output by way of the light-output opening 11A while being focused in the direction perpendicular to the axial direction of the cylindrical lens 17. Accordingly, a light irradiation zone IA that extends linearly, in the axial direction of the cylindrical lens 17, is formed on the light irradiation surface W at the position of the focusing point Fs' of the cylindrical lens.

Now, when a longer linear light irradiation zone is desired, light sources can be lined up as shown in FIG. 6.

In this inkjet printer, as stated above, the head portion 62 is located so that the substrate R is positioned at or in the vicinity of the position of the focusing point Fs' of the cylindrical lenses 17 in the light irradiation devices 62A, 62B and moves when the discharge lamps 12 are lit; by this means, the light from the discharge lamps 12 is linearly focused in the direction perpendicular to the direction of travel of the head portion 62 and irradiates the substrate R, by which means the ultraviolet light-curable ink is cured immediately after impacting the substrate R.

With light irradiation devices of the constitutions shown in FIGS. 9 & 10(a), 10(b), it is possible to obtain the same effects as with that of FIG. 8, but compared with the construction in FIG. 8, those in FIGS. 9 & 10 have smaller cylindrical lenses, and so there are the advantages that the weight of the light irradiation devices is lighter, and the printing speed and the speed of pattern formation are faster.

In the explanation above, the recording of images and formation of patterns by means of moving the head portion relative to the substrate has been explained, but the light irradiation device of this invention can be applied to inkjet printers in which the position of the head portion is fixed and the image is recorded or the pattern is formed by intermittently, for example, transporting the substrate.

Further, the light irradiation device of this invention can be applied not just to light-curing inkjet printers, but also to equipment that attaches liquid-crystal or other panels by light irradiation of a light-curable adhesive spread linearly between two transparent substrates in order to adhere the two transparent substrates. In this type of panel attachment equipment, it is possible to design the length of the light irradiation zone that extends linearly from the light irradiation device to suit the length of the light-curable adhesive that is spread linearly between the transparent substrates.

What is claimed is:

1. A light irradiation device, comprising:
at least one short-arc type discharge lamp that comprises a pair of electrodes which face each other within a discharge vessel,
a reflector surrounding the at least one discharge lamp so as to reflect light from the discharge lamp, and
a cylindrical lens that focuses light reflected by the reflector in a uniaxial direction in a manner forming a light irradiation zone having an elongated linear shape.

2. A light irradiation device as described in claim 1, in which the reflector has a reflecting surface that is a paraboloid of revolution centered on an optical axis of the lamp.

3. A light irradiation device as described in claim 2, in which there are reflecting mirrors on a light output side of the reflector, said reflecting mirrors having cylindrical reflecting surfaces that are parabolic in cross section,
wherein the reflecting mirrors are located on both sides of the cylindrical lens, light reflected there being directed into the light irradiation zone having said elongated linear shape and
wherein the cylindrical lens focuses that part of the light reflected by the reflector that is not incident on the reflecting mirrors.

4. A light irradiation device as described in claim 1, in which the reflector has a reflecting surface that is an ellipsoid of revolution centered on an optical axis of the lamp and the cylindrical lens is located in a position the light condensed by the reflector is smaller in size than the opening of the reflector.

5. A light irradiation device according to claim 1, wherein said at least one short-arc type discharge lamp comprises a plurality of short-arc type discharge lamps, each of which is surrounded by a respective said reflector with a said cylindrical lens being provided for focusing the light reflected by a respective said reflector;
wherein the plurality of lamps are lined up with at least a part of adjoining light irradiation zones overlapping in a direction perpendicular to a direction in which the light irradiation devices are lined up.

6. A light irradiation device as described in claim 5, in which each reflector has a reflecting surface that is a paraboloid of revolution centered on an optical axis of the lamp.

7. A light irradiation device as described in claim 6, in which there are reflecting mirrors on a light output side of each reflector, each reflecting mirror having cylindrical reflecting surfaces that are parabolic in cross section,
wherein the reflecting mirrors are located on both sides of the respective cylindrical lens, light reflected there being directed into the light irradiation zone having said elongated linear shape and
wherein each cylindrical lens focuses that part of the light reflected by the reflector that is not incident on the reflecting mirrors.

8. A light irradiation device as described in claim 5, in which each reflector has a reflecting surface that is an ellipsoid of revolution centered on an optical axis of the respective lamp and the respective cylindrical lens is located in a position the light focused by the respective reflector is smaller in size than the opening of the reflector.

9. An inkjet printer having a head portion in which there is an inkjet head that ejects a light-curable liquid material onto a substrate and a light irradiation device that irradiates light to cure the liquid material that is ejected onto and impacts the substrate, the inkjet printer forming a pattern by curing the liquid material by means of ejecting the liquid material from the inkjet head while there is relative movement between the head portion and the substrate and irradiating the liquid material that has impacted the substrate with light from the light irradiation device,
wherein the light irradiation device, comprises:
at least one short-arc type discharge lamp that comprises a pair of electrodes which face each other within a discharge vessel,
a reflector surrounding the at least one discharge lamp so as to reflect light from the discharge lamp, and
a cylindrical lens that focuses light reflected by the reflector in a uniaxial direction in a manner forming a light irradiation zone having an elongated linear shape.

10. An inkjet printer according to claim 9, wherein a respective said light irradiation device is provided on each of opposite sides of the inkjet head.

11. An inkjet printer according to claim 9, wherein said at least one short-arc type discharge lamp comprises a plurality of short-arc type discharge lamps, each of which is surrounded by a respective said reflector with a said cylindrical lens being provided for focusing the light reflected by a respective said reflector;
wherein the plurality of lamps are lined up with at least a part of adjoining light irradiation zones overlapping in a direction perpendicular to a direction in which the light irradiation devices are lined up.

12. An inkjet printer as described in claim 11, in which each reflector has a reflecting surface that is a paraboloid of revolution centered on an optical axis of the lamp.

13. An inkjet printer as described in claim 12, in which there are reflecting mirrors on a light output side of each reflector, each reflecting mirrors having cylindrical reflecting surfaces that are parabolic in cross section,
wherein the reflecting mirrors are located on both sides of the respective cylindrical lens, light reflected there being directed into the light irradiation zone having said elongated linear shape and
wherein each cylindrical lens focuses that part of the light reflected by the reflector that is not incident on the reflecting mirrors.

14. An inkjet printer as described in claim 11, in which each reflector has a reflecting surface that is an ellipsoid of revolution centered on an optical axis of the respective lamp and the respective cylindrical lens is located in a position the light condensed by the respective reflector is smaller in size than the opening of the reflector.
